(19) United States
(12) Patent Application Publication
(10) Pub. No.: US 2026/0233678 A1
(43) Pub. Date: Aug. 13, 2026

(54) SIDE BAR, STEP ASSEMBLY AND VEHICLE

(71) Applicant: T-MAX (HANGZHOU) TECHNOLOGY CO., LTD., Hangzhou (CN)

(72) Inventors: Hanxin ZHANG, Hangzhou (CN); Yiming WANG, Hangzhou (CN); Xinfa DU, Hangzhou (CN); Ke WANG, Hangzhou (CN)

(21) Appl. No.: 19/465,605

(22) Filed: Jan. 30, 2026

(30) Foreign Application Priority Data
Feb. 11, 2025 (CN) 202520211466.X

(51) Int. Cl. B60R 3/02; B60R 3/00

(52) U.S. Cl. CPC B60R 3/02; B60R 3/002

(57) ABSTRACT

Disclosed are a side bar, a step assembly comprising a side bar, and a vehicle having a step assembly, in accordance with the present technology. In some embodiments, a side bar includes a plurality of side bar body segments, each of the plurality of side bar body segments has a first end and a second end in a longitudinal direction of the side bar body segment, two adjacent side bar body segments of the plurality of side bar body segments are a first side bar body segment and a second side bar body segment, and a first end of the first side bar body segment and a second end of the second side bar body segment are opposite to each other and detachably connected.

### CROSS-REFERENCE TO RELATED APPLICATIONS

The present application claims priority to and benefits of Chinese Patent Application No. 202520211466.X, filed on February 11, 2025. The entire content of the aforementioned patent application is incorporated by reference for all purposes.

### TECHNICAL FIELD

The present technology relates to the field of vehicle accessories, and particularly to a side bar and a step assembly with a side bar for a vehicle.

### BACKGROUND

A side bar for a vehicle is a protective device mounted to a side surface of the vehicle and may improve aesthetics and safety of the vehicle. Typically, a side bar may be used as a step to assist in getting on and off the vehicle.

### SUMMARY

Disclosed are devices, systems, and methods for a side bar and step assembly with a side bar for a vehicle.

In some embodiments in accordance with the present technology, a side bar includes a plurality of side bar body segments, each of the plurality of side bar body segments has a first end and a second end in a longitudinal direction of the side bar body segment, two adjacent side bar body segments of the plurality of side bar body segments are a first side bar body segment and a second side bar body segment, and a first end of the first side bar body segment and a second end of the second side bar body segment are opposite to each other and detachably connected.

In some embodiments in accordance with the present technology, a step assembly includes: a side bar including a plurality of side bar body segments, where each of the plurality of side bar body segments has a first end and a second end in a longitudinal direction of the side bar body segment, two adjacent side bar body segments of the plurality of side bar body segments are a first side bar body segment and a second side bar body segment, and a first end of the first side bar body segment and a second end of the second side bar body segment are opposite to each other and detachably connected; and a retractable step device, including: at least one step having a stepping-on surface, and including a first end and a second end along a length direction of the at least one step; a plurality of mounting supports; a plurality of step supports, where two adjacent step supports of the plurality of step supports are a first step support and a second step support, a first side of the first step support is opposite a second side of the second step support, the first end of the at least one step is connected to the first side of the first step support, and the second end of the at least one step is connected to the second side of the second step support; and at least two support arms, where a first end of each of the at least two support arms is pivotally connected to a corresponding mounting support of the plurality of mounting supports and a second end of each of the at least two support arms is pivotally connected to a corresponding step support of the plurality of step supports to move the corresponding step support and the at least one step between an extended position and a retracted position.

In some embodiments in accordance with the present technology, a vehicle includes a vehicle body and a step assembly connected to the vehicle body. The step assembly can be configured as the step assembly described above.

The subject matter described in this patent document can be implemented in specific ways that provide one or more of the following features.

### BRIEF DESCRIPTION OF THE DRAWINGS

FIG. 1 shows a diagram depicting an exploded view of an example embodiment of a side bar in accordance with the present technology.

FIG. 2 shows a diagram depicting a perspective view of an example embodiment of a side bar assembled in accordance with the present technology.

FIG. 3 shows a diagram depicting a schematic view of an example embodiment of a step assembly in accordance with the present technology.

FIG. 4 shows a diagram depicting another schematic view of the step assembly shown in FIG. 3.

FIG. 5 shows a diagram depicting an exploded view of another example embodiment of a side bar in accordance with the present technology.

FIG. 6 shows a diagram depicting a perspective view of another example embodiment of a side bar assembled in accordance with the present technology.

FIG. 7 shows a diagram depicting a schematic view of another example embodiment of a step assembly in accordance with the present technology.

FIG. 8 shows a diagram depicting a schematic view of another example embodiment of a step assembly in accordance with the present technology.

FIG. 9 shows a diagram depicting another schematic view of the step assembly shown in FIG. 8.

### DETAILED DESCRIPTION

Conventionally, in order to adapt to different types of vehicles, it has been necessary to produce side bars with different lengths, which has resulted in complicated production processes and high costs. Furthermore, conventional side bars cause challenges and problems in the field, including large packaging, high transportation costs, and large space occupation.

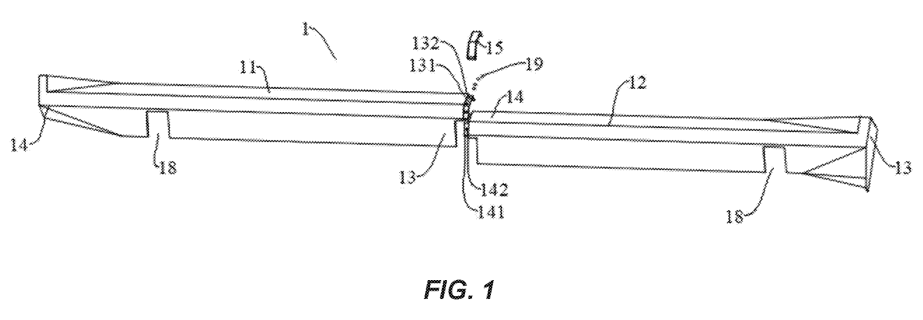

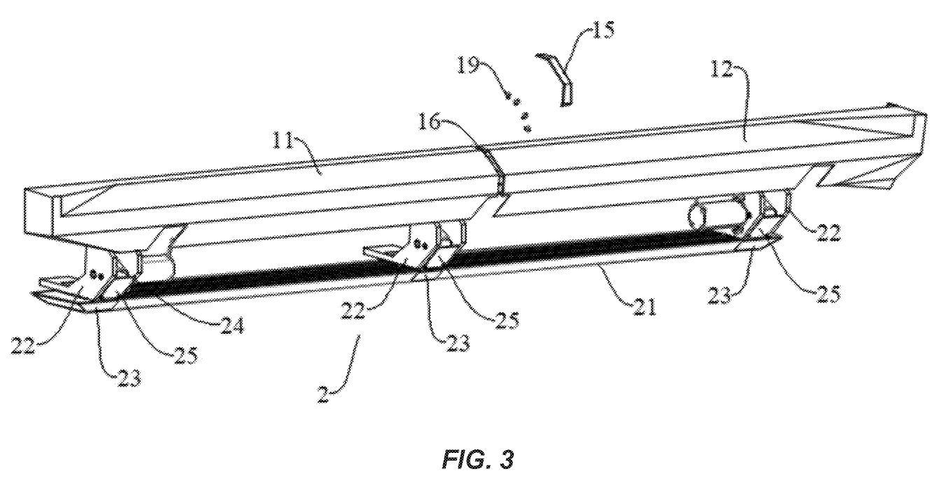

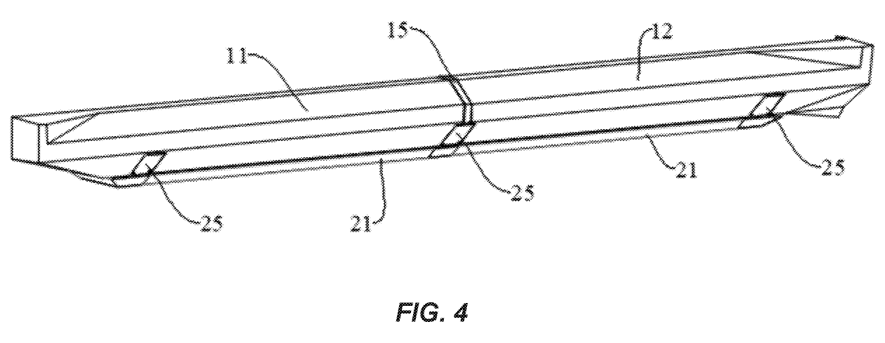

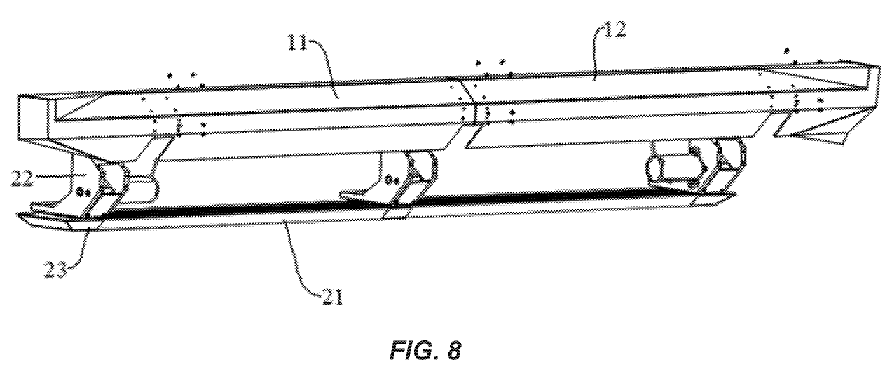

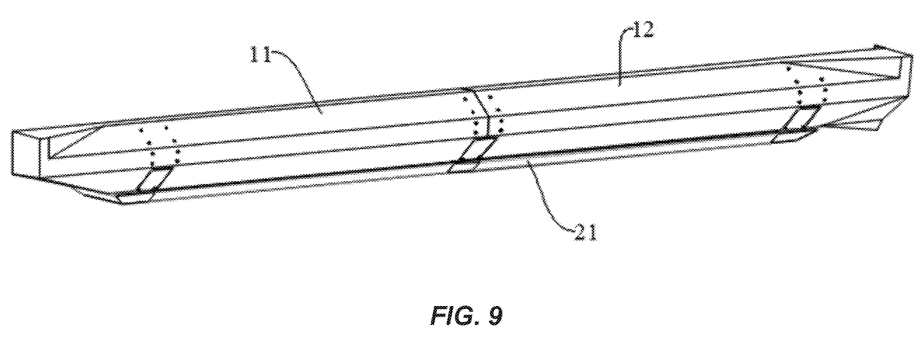

Side bars according to example embodiments of the present technology are described below that overcome these limitations with conventional side bar devices, systems and methods. Some example embodiments of the disclosed side bar technology are shown in FIG. 1 to FIG. 9, which are illustrative and not limiting.

As shown in FIG. 1, an exemplary side bar, shown as side bar 1, according to example embodiments of the present technology, includes a plurality of side bar body segments. Each side bar body segment of the side bar 1 has a first end 13 and a second end 14 in a longitudinal (length) direction of the side bar body segment. In some embodiments, the side bar 1 includes two side bar body segments, i.e., the side bar 1 includes the first side bar body segment 11 and the second side bar body segment 12. For example, two adjacent side bar body segments can include a first side bar body segment 11 and a second side bar body segment 12, and a first end 13 of the first side bar body segment 11 and a second end 14 of the second side bar body segment 12 are opposite to each other and detachably connected.

For example, when the side bar 1 is to be mounted to a vehicle, the plurality of side bar body segments are sequentially connected to complete the assembling (e.g., the first end 13 of the first side bar body segment 11 of the two adjacent side bar body segments is connected to the second end 14 of the second side bar body segment 12 of the two adjacent side bar body segments), and then the side bar 1 is connected to the vehicle. When the side bar 1 needs to be packaged and transported, the plurality of side bar body segments may be separated in order to reduce a length of the side bar and adapt to more stacking and storing ways, e.g., thereby reducing the transportation cost. Moreover, since the side bar 1 includes the plurality of side bar body segments, it is easy to manufacture the side bar 1.

The side bar 1 according to the embodiments of the present technology has advantages of easy manufacturing, low cost, and easy transportation.

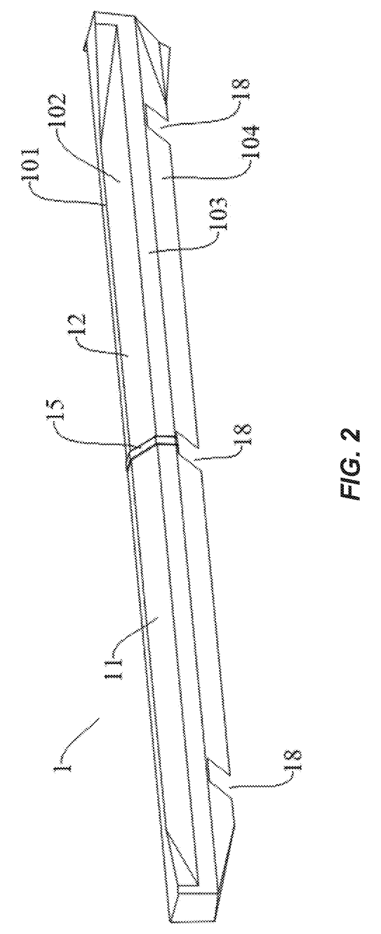

As shown in FIG. 2, the side bar 1 has a concave surface (an inner surface) at a side of the side bar 1 facing towards the vehicle, and the side bar 1 has a convex surface (an outer surface) at a side of the side bar 1 facing away from the vehicle.

In some embodiments, the convex surface (outer surface) of the side bar 1 facing away from the vehicle includes a first side surface 101, a second side surface 102, a third side surface 103, and a fourth side surface 104 sequentially connected in a peripheral direction of the side bar 1. The first side surface 101 faces upwards, the third side surface 103 faces away from the vehicle, the second side surface 102 and the fourth side surface 104 are inclined surfaces, an upper edge of the second side surface 102 is connected to the first side surface 101 (an outer edge of the first side surface 101), and a lower edge of the second side surface 102 is connected to the third side surface 103. The second side surface 102 is inclined downwards in a direction running away from the vehicle, an upper edge of the fourth side surface 104 is connected to a lower edge of the third side surface 103, and the fourth side surface 104 is inclined downwards in a direction approaching the vehicle. Specifically, a distance between the vehicle and the convex surface (outer surface) of the side bar 1 first increases and then decreases from up to down.

In some embodiments of the side bar 1, for example, both ends of the side bar 1 have an end face, and both ends of the side bar 1 include a plurality of transition bevels. For example, both ends of the side bar 1 include a first transition bevel connected to the first side surface 101 and the second side surface 102, the first transition bevel faces away from the vehicle, a dimension of the first transition bevel in an up-down direction decreases along a direction running away from the end of the side bar 1 in a length direction of the side bar 1, a distance between the first transition bevel and the vehicle decreases along the direction running away from the end of the side bar 1 in the length direction of the side bar 1, and an upper edge of the first transition bevel is connected to the outer edge of the first side surface 101. Both ends of the side bar 1 include a second transition bevel connected to the fourth side surface 104, the second transition bevel is inclined downwards along the direction running away from the end of the side bar 1 in the length direction of the side bar 1, and a dimension of the second transition bevel in a width direction of the vehicle decreases along the direction running away from the end of the side bar 1 in the length direction of the side bar 1.

As shown in FIG. 1 to FIG. 4, in some embodiments of the side bar 1, for example, the first end 13 of the first side bar body segment 11 includes a first lapping plate 131. The first lapping plate 131 has a plurality of first connection holes 132. The second end 14 of the second side bar body segment 12 includes a second lapping plate 141, and the second lapping plate 141 has a plurality of second connection holes 142. The first lapping plate 131 and the second lapping plate 141 are lapped and stacked, the plurality of first connection holes 132 are in one-to-one correspondence with the plurality of second connection holes 142, and the first end 13 of the first side bar body segment 11 and the second end 14 of the second side bar body segment 12 are connected by fasteners passing through the first connection holes 132 and the second connection holes 142. Specifically, after the first lapping plate 131 and the second lapping plate 141 are lapped and stacked, a plurality of fasteners pass through the plurality of first connection holes 132 and the plurality of second connection holes 142 in one-to-one correspondence, so that the first end 13 of the first side bar body segment 11 and the second end 14 of the second side bar body segment 12 are connected. For example, the fasteners are bolts 19.

In some embodiments, the side bar 1 further includes a cover member 15, the cover member 15 covers a groove 16 defined by the first lapping plate 131 and the second lapping plate 141 and located between the first end 13 of the first side bar body segment 11 and the second end 14 of the second side bar body segment 12, and an outer surface of the cover member 15 is flush with an outer peripheral surface of the first side bar body segment 11 and an outer peripheral surface of the second side bar body segment 12. As a result, the cover member 15 may cover the groove 16 at a joint of the first side bar body segment 11 and the second side bar body segment 12 so as to hide the groove 16, thus making an outer surface of the side bar 1 smoother. For example, a plurality of outer surfaces of the cover member 15 are coplanar with the first side surface 101, the second side surface 102 and the third side surface 103 of the side bar 1, respectively.

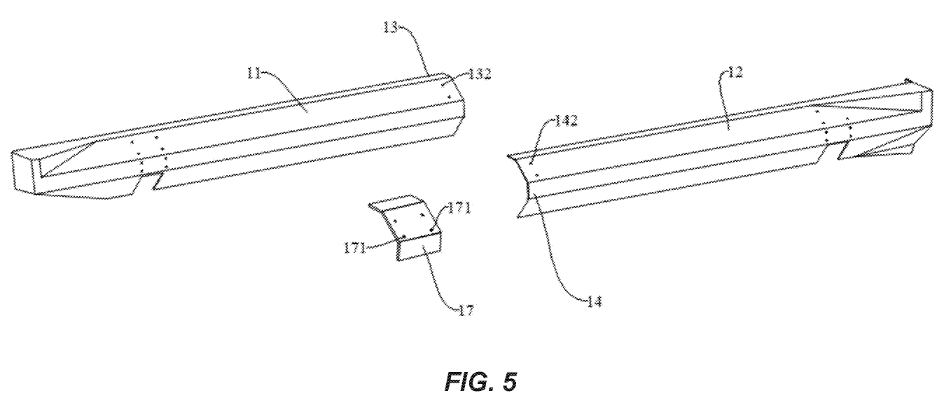

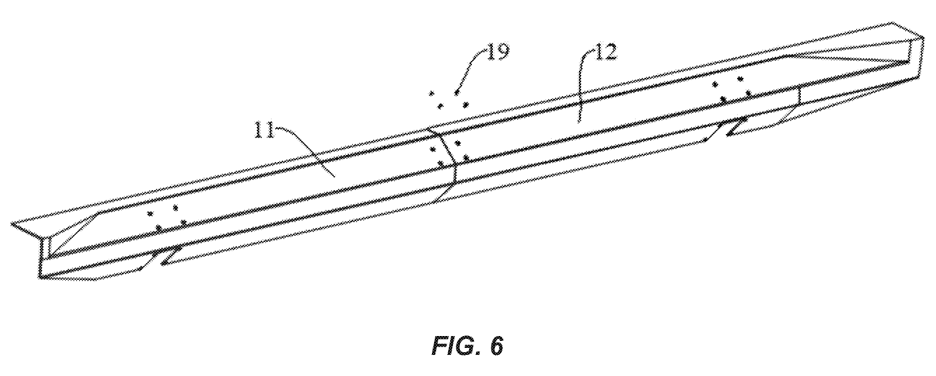

As shown in FIG. 5 and FIG. 6, in some embodiments of the side bar 1, for example, the first end 13 of the first side bar body segment 11 has a plurality of first connection holes 132, and the second end 14 of the second side bar body segment 12 has a plurality of second connection holes 142. The side bar 1 further can include a connection plate 17, the connection plate 17 has third connection holes 171 corresponding to the first connection holes 132 and the second connection holes 142. The connection plate 17 is fitted to an inner side of the first side bar body segment 11 and an inner side of the second side bar body segment 12, the first end 13 of the first side bar body segment 11 butts against the second end 14 of the second side bar body segment 12, the connection plate 17 is connected to the first side bar body segment 11 by a fastener passing through the first connection hole 132 and the third connection hole 171, and the connection plate 17 is connected to the second side bar body segment 12 by a fastener passing through the second connection hole 142 and the third connection hole 171. That is, the two adjacent side bar body segments (the first side bar body segment 11 and the second side bar body segment 12) are connected to each other by the connection plate 17.

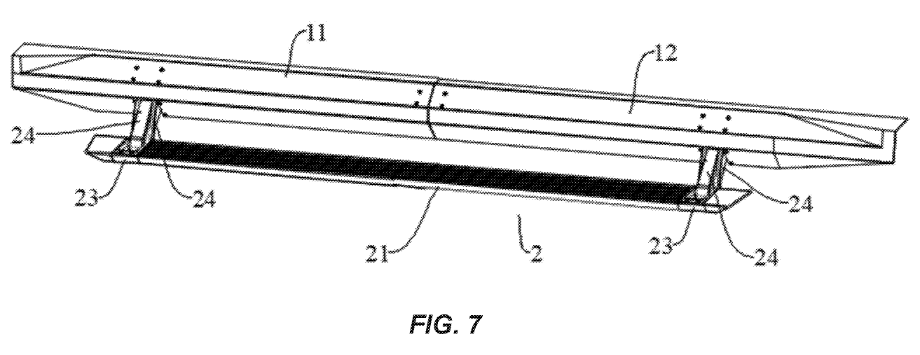

As shown in FIG. 7 to FIG. 9, the disclosed technology provides a retractable step device 2 with a step assembly that includes the side bar 1, in accordance with example embodiments of the present technology and.

The retractable step device 2 includes at least one step 21, a plurality of mounting supports 22, a plurality of step supports 23 and at least two support arms 24.

The step 21 has a stepping-on surface, and the step 21 has a first end and a second end along a length direction of the step 21. Two adjacent step supports 23 include a first step support and a second step support. A first side of the first step support is opposite to a second side of the second step support. The first end of the step 21 is connected to the first side of the first step support, and the second end of the step 21 is connected to the second side of the second step support. Specifically, the plurality of step supports 23 are arranged side by side in the length direction of the step 21, and both ends of the step 21 in the length direction of the step 21 are connected to one step support 23, respectively, so that the step 21 is connected to the step supports 23.

A first end of the support arm 24 is pivotally connected to the mounting support 22, and a second end of the support arm 24 is pivotally connected to the step support 23, so as to move the step support 23 and the step 21 between an extended position and a retracted position. As a result, the support arm 24 may drive the step 21 to move between the extended position and the retracted position by the step support 23, thus facilitating the step 21 to be extended and retracted.

As shown in FIG. 1 to FIG. 3 and FIG. 7 to FIG. 9, in some embodiments, each of the second end 14 of the first side bar body segment 11 and the first end 13 of the second side bar body segment 12 is detachably connected to the mounting support 22, and an outer side of at least one of the first side bar body segment 11 and the second side bar body segment 12 has a groove, e.g., configured as a substantially U-shaped avoidance groove 18, for avoiding the mounting support 22. The mounting support 22 includes a baffle plate 25, and the baffle plate 25 is located in the avoidance groove 18 in the retracted position. Specifically, the support arm 24 extends out of the avoidance groove 18 in the extended position, and the baffle plate 25 covers the avoidance groove 18 in the retracted position. For example, in some embodiments, the side bar 1 includes three avoidance grooves 18, the first side bar body segment 11 and the second side bar body segment 12 both include one avoidance groove 18, and the joint of the first side bar body segment 11 and the second side bar body segment 12 defines one avoidance groove 18. In some embodiments, three mounting supports 22, three step supports 23, and two steps 21 are provided.

In some embodiments, the mounting support 22 is connected to the connection plate 17. In some embodiments, the mounting support 22 serves as the connection plate 17. The mounting support 22 and the first side bar body segment 11 are connected by the fastener passing through the first connection hole 132 and the third connection hole 171, and the mounting support 22 is connected to the second side bar body segment 12 by the fastener passing through the second connection hole 142 and the third connection hole 171.

The present technology also proposes a vehicle that includes a vehicle body and the step assembly according to the embodiments of the present technology, where the step assembly is connected to the vehicle body. Thus, such a vehicle according to the example embodiments of the present technology has the advantages of the side bar 1, e.g., providing a side bar that is low cost and easy-to-manufacture and transport.

Some example embodiments of side bars, step assemblies, and vehicles, in accordance with the present technology, are described in above and shown in the accompanying drawings. The example embodiments described herein with reference to the accompanying drawings are illustrative and are intended to be used to explain the present technology, but are not to be construed as a limitation of the present technology.

In the present disclosure, it is to be understood that the terms “central,” “longitudinal,” “transverse,” “length,” “width,” “thickness,” “up,” “down,” “front,” “rear,” “left,” “right,” “vertical,” “horizontal,” “top,” “bottom,” “inner,” “outer,” “clockwise,” “counterclockwise,” “axial,” “radial,” “circumferential,” etc. indicate orientations or positional relationships based on those shown in the drawings, are only intended to facilitate descriptions of the present technology and to simplify descriptions, and are not intended to indicate or imply that the device or element referred to must have a particular orientation, and be constructed and operated in a particular orientation. Therefore, these terms cannot be understood as limitations of the present technology.

Moreover, the terms “first” and “second” are used for purposes of description only and cannot be understood as indicating or implying relative importance or implicitly specifying the number of technical features indicated. Thus, a feature defined with the term “first” or “second” may expressly or impliedly include at least one such feature. In the present disclosure, “a plurality of” means at least two, such as two, three, etc., unless expressly and specifically limited otherwise.

In the present disclosure, unless expressly specified or limited otherwise, the terms “mount,” “connect,” “couple,” “fix,” and the like should be understood broadly and may indicate, such as a fixed connection, a detachable connection, or a one-piece unit; a mechanical connection, an electrical connection, or a communication with each other; a direct connection, an indirect connection through an intermediate media, and intercommunication or interaction of two elements, unless expressly limited otherwise. For those skilled in the art, the specific meaning of the above terms in the present disclosure may be understood according to the specific situations.

In the present disclosure, unless expressly specified or limited otherwise, a first feature being “above” or “below” a second feature may indicate a direct contact between the first feature and the second feature, or an indirect contact between the first feature and the second feature through an intermediate medium. Furthermore, the first feature being “on,” “above,” and “over” the second feature may indicate that the first feature is directly above or obliquely above the second feature, or only indicate that the first feature has a height larger than the second feature. The first feature being “below,” “under,” and “underneath” the second feature may indicate that the first feature is directly below or obliquely below the second feature, or only indicate that the first feature has a height less than the second feature.

In the present disclosure, the terms “an embodiment,” “some embodiments,” “an

example,” “a specific example,” or “some examples” mean that the specific features, structures, materials, or characteristics described in connection with the embodiment or example are included in at least one embodiment or example of the present technology. In the specification, schematic expressions of the above terms do not necessarily refer to the same embodiments or examples. Furthermore, the specific features, structures, materials, or characteristics described may be combined in any one or more embodiments or examples in a suitable manner. Moreover, without contradicting each other, those skilled in the art may combine and associate different embodiments or examples and features of different embodiments or examples described in the specification.

Although the embodiments of the present technology have been shown and described above, it may be understood that the above embodiments are illustrative and are not to be understood as limitations of the present technology, and that those skilled in the art may make changes, modifications, substitutions, and variations of the above embodiments within the scope of the present technology.

### Conclusion

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A side bar, comprising:
a plurality of side bar body segments,
wherein each of the plurality of side bar body segments has a first end and a second end in a longitudinal direction of a side bar body segment,
wherein two adjacent side bar body segments of the plurality of side bar body segments are a first side bar body segment and a second side bar body segment, and
wherein a first end of the first side bar body segment and a second end of the second side bar body segment are opposite to each other and detachably connected.

2. The side bar according to claim 1, wherein the first end of the first side bar body segment comprises a first lapping plate, the first lapping plate has a plurality of first connection holes, the second end of the second side bar body segment comprises a second lapping plate, the second lapping plate has a plurality of second connection holes, the first lapping plate and the second lapping plate are lapped and stacked, the plurality of first connection holes are in one-to-one correspondence with the plurality of second connection holes, and the first end of the first side bar body segment and the second end of the second side bar body segment are connected by fasteners passing through the plurality of first connection holes and the plurality of second connection holes.

3. The side bar according to claim 2, wherein the side bar further comprises a cover member, the cover member covers a groove defined by the first lapping plate and the second lapping plate and located between the first end of the first side bar body segment and the second end of the second side bar body segment, and an outer surface of the cover member is flush with an outer peripheral surface of the first side bar body segment and an outer peripheral surface of the second side bar body segment.

4. The side bar according to claim 1, wherein the first end of the first side bar body segment has a plurality of first connection holes, the second end of the second side bar body segment has a plurality of second connection holes, the side bar further comprises a connection plate, the connection plate has third connection holes corresponding to the plurality of first connection holes and the plurality of second connection holes, the connection plate is fitted to an inner side of the first side bar body segment and an inner side of the second side bar body segment, the first end of the first side bar body segment butts against the second end of the second side bar body segment, the connection plate is connected to the first side bar body segment by a fastener passing through each of the plurality of first connection holes and each of the third connection holes, and the connection plate is connected to the second side bar body segment by a fastener passing through each of the plurality of second connection holes and each of the third connection holes.

5. The side bar according to claim 1, wherein the side bar has a concave surface at a first side of the side bar configured to face towards a vehicle when the side bar is mounted to the vehicle, and wherein the side bar has a convex surface at a second side of the side bar facing away from the vehicle when mounted to the vehicle.

6. The side bar according to claim 5, wherein the convex surface comprises a first side surface, a second side surface, a third side surface, and a fourth side surface sequentially connected in a peripheral direction of the side bar, wherein, when the side bar is mounted to a vehicle, the first side surface is configured to face upwards and the third side surface faces away from the vehicle, and wherein the second side surface and the fourth side surface are inclined surfaces.

7. The side bar according to claim 6, wherein an upper edge of the second side surface is connected to the first side surface and a lower edge of the second side surface is connected to the third side surface.

8. The side bar according to claim 6, wherein the second side surface is inclined downwards in a direction away from the vehicle, and the fourth side surface is inclined downwards in a direction towards the vehicle.

9. The side bar according to claim 8, wherein an upper edge of the fourth side surface is connected to a lower edge of the third side surface.

10. The side bar according to claim 1, wherein the side bar comprises a plurality of transition bevels at opposing ends of the side bar.

11. A step assembly, comprising:
a side bar comprising a plurality of side bar body segments, wherein each of the plurality of side bar body segments has a first end and a second end in a longitudinal direction of a side bar body segment, wherein two adjacent side bar body segments of the plurality of side bar body segments are a first side bar body segment and a second side bar body segment, and wherein a first end of the first side bar body segment and a second end of the second side bar body segment are opposite to each other and detachably connected; and
a retractable step device, comprising:
at least one step having a stepping-on surface, and comprising a first end and a second end along a length direction of the at least one step,
a plurality of mounting supports,
a plurality of step supports, wherein two adjacent step supports of the plurality of step supports are a first step support and a second step support, a first side of the first step support is opposite a second side of the second step support, the first end of the at least one step is connected to the first side of the first step support, and the second end of the at least one step is connected to the second side of the second step support, and
at least two support arms, wherein a first end of each of the at least two support arms is pivotally connected to a corresponding mounting support of the plurality of mounting supports and a second end of each of the at least two support arms is pivotally connected to a corresponding step support of the plurality of step supports to move the corresponding step support and the at least one step between an extended position and a retracted position.

12. The step assembly according to claim 11, wherein each of the second end of the first side bar body segment and the first end of the second side bar body segment is detachably connected to a corresponding mounting support the plurality of mounting supports, an outer side of at least one of the first side bar body segment and the second side bar body segment has a substantially U-shaped avoidance groove for avoiding the corresponding mounting support, the corresponding mounting support comprises a baffle plate, and the baffle plate is located in the avoidance groove in the retracted position.

13. The step assembly according to claim 11, wherein the first end of the first side bar body segment comprises a first lapping plate, the first lapping plate has a plurality of first connection holes, the second end of the second side bar body segment comprises a second lapping plate, the second lapping plate has a plurality of second connection holes, the first lapping plate and the second lapping plate are lapped and stacked, the plurality of first connection holes are in one-to-one correspondence with the plurality of second connection holes, and the first end of the first side bar body segment and the second end of the second side bar body segment are connected by fasteners passing through the plurality of first connection holes and the plurality of second connection holes.

14. The step assembly according to claim 13, wherein the side bar further comprises a cover member, the cover member covers a groove defined by the first lapping plate and the second lapping plate and located between the first end of the first side bar body segment and the second end of the second side bar body segment, and an outer surface of the cover member is flush with an outer peripheral surface of the first side bar body segment and an outer peripheral surface of the second side bar body segment.

15. The step assembly according to claim 11, wherein the first end of the first side bar body segment has a plurality of first connection holes, the second end of the second side bar body segment has a plurality of second connection holes, the side bar further comprises a connection plate, the connection plate has third connection holes corresponding to the plurality of first connection holes and the plurality of second connection holes, the connection plate is fitted to an inner side of the first side bar body segment and an inner side of the second side bar body segment, the first end of the first side bar body segment butts against the second end of the second side bar body segment, the connection plate is connected to the first side bar body segment by a fastener passing through each of the plurality of first connection holes and each of the third connection holes, and the connection plate is connected to the second side bar body segment by a fastener passing through each of the plurality of second connection holes and each of the third connection holes.

16. A vehicle, comprising:
a vehicle body; and
a step assembly connected to the vehicle body,
wherein the step assembly comprises:
a side bar comprising a plurality of side bar body segments, wherein each of the plurality of side bar body segments has a first end and a second end in a longitudinal direction of a side bar body segment, wherein two adjacent side bar body segments of the plurality of side bar body segments are a first side bar body segment and a second side bar body segment, and wherein a first end of the first side bar body segment and a second end of the second side bar body segment are opposite to each other and detachably connected, and
a retractable step device, comprising:
at least one step having a stepping-on surface, and comprising a first end and a second end along a length direction of the at least one step,
a plurality of mounting supports,
a plurality of step supports, wherein two adjacent step supports of the plurality of step supports are a first step support and a second step support, a first side of the first step support is opposite a second side of the second step support, the first end of the at least one step is connected to the first side of the first step support, and the second end of the at least one step is connected to the second side of the second step support; and
at least two support arms, wherein a first end of each of the at least two support arms is pivotally connected to a corresponding mounting support of the plurality of mounting supports and a second end of each of the at least two support arms is pivotally connected to a corresponding step support of the plurality of step supports to move the corresponding step support and the at least one step between an extended position and a retracted position.

17. The vehicle according to claim 16, wherein each of the second end of the first side bar body segment and the first end of the second side bar body segment is detachably connected to a corresponding mounting support the plurality of mounting supports, an outer side of at least one of the first side bar body segment and the second side bar body segment has a substantially U-shaped avoidance groove for avoiding the corresponding mounting support, the corresponding mounting support comprises a baffle plate, and the baffle plate is located in the avoidance groove in the retracted position.

18. The vehicle according to claim 16, wherein the first end of the first side bar body segment comprises a first lapping plate, the first lapping plate has a plurality of first connection holes, the second end of the second side bar body segment comprises a second lapping plate, the second lapping plate has a plurality of second connection holes, the first lapping plate and the second lapping plate are lapped and stacked, the plurality of first connection holes are in one-to-one correspondence with the plurality of second connection holes, and the first end of the first side bar body segment and the second end of the second side bar body segment are connected by fasteners passing through the plurality of first connection holes and the plurality of second connection holes.

19. The vehicle according to claim 18, wherein the side bar further comprises a cover member, the cover member covers a groove defined by the first lapping plate and the second lapping plate and located between the first end of the first side bar body segment and the second end of the second side bar body segment, and an outer surface of the cover member is flush with an outer peripheral surface of the first side bar body segment and an outer peripheral surface of the second side bar body segment.

20. The vehicle according to claim 16, the first end of the first side bar body segment has a plurality of first connection holes, the second end of the second side bar body segment has a plurality of second connection holes, the side bar further comprises a connection plate, the connection plate has third connection holes corresponding to the plurality of first connection holes and the plurality of second connection holes, the connection plate is fitted to an inner side of the first side bar body segment and an inner side of the second side bar body segment, the first end of the first side bar body segment butts against the second end of the second side bar body segment, the connection plate is connected to the first side bar body segment by a fastener passing through each of the plurality of first connection holes and each of the third connection holes, and the connection plate is connected to the second side bar body segment by a fastener passing through each of the plurality of second connection holes and each of the third connection holes.
